(19) United States
(12) Patent Application Publication
(10) Pub. No.: US 2004/0037437 A1
(43) Pub. Date: Feb. 26, 2004

(54) Directional microphone

(76) Inventors: Ian Robert Symons, Woodand (AU); Ian William Taig, Wheelers Hill (AU)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/416,672

(22) PCT Filed: Nov. 9, 2001
(86) PCT No.: PCT/AU01/01459

(30) Foreign Application Priority Data
Nov. 13, 2000 (AU) PR 1412

(51) Int. Cl. H04R 3/00; H04R 1/02

(52) U.S. Cl. 381/92; 381/91; 381/356

(57) ABSTRACT

A directional micro-phone is disclosed which comprises a microphone array (3) having a plurality of microphone elements (4,5,12,13) of which the element (4) is a rear element and the other elements arc forward elements. A processor (19,31) is connected to the elements. The processor can be a hardware processor for processing signals or it can be a software controlled system for processing signals. The processor one of the forward elements (5,12,13) and thereafter establishes a window of opportunity for receipt of the wave at the rear element (4). The window of opportunity is set such that only waves emanating from a particular direction will arrive in that time frame, thereby enabling acoustic waves from that direction to the process by the microphone and other waves from different directions eliminated. The angle of arc of the microphone from which acoustic waves are received and processed can be set by changing the size of the window of opportunity t3-t2. In the hardware implementation, the processor includes filters (21,22), zero cross-over detectors (23,24), monostables (25,26) and flip-flop (28) for setting a timing signal and triggering the flip-flop (28) to control the switch (29) so that if a wave does arrive at the element (4) within the bandwidth of the filters (21,22), an audio signal corresponding to the wave is transmitted from the element (4) through the switch (29) to an output (30).

### FIELD OF THE INVENTION

This invention relates to a directional microphone.

### BACKGROUND ART

Current microphone technology has many limitations. Microphones are the weakest link in hi-fi systems because they are regarded as adding the most distortion to the recorded or amplified signal. Studio and cinematic productions are also constrained by microphone usage. In general, microphones need to be placed closed to a subject to minimise the pick up of unwanted sounds from the surroundings. This interferes visually with filming. Distance placement in a quiet environment can also be a problem as the effective pick up range is limited. Outside broadcasts, such as live interviews, are subject to the above limitations plus suffer from much higher levels and diverse sources of unwanted sound which can be received by the microphone and therefore transmitted with the required sound signals which the microphone is intended to receive.

Another major problem with directional microphones is sound coloration (ie. frequency response of the microphone). Pointing a microphone to one side varies the frequency response and can therefore distort a person's voice which is recorded by the microphone.

Most common microphones are either electret condenser microphones which operate by an electrostatic membrane, or dynamic microphones which operate by a moving coil. The electret microphone is the most commonly used professional microphone. Microphones have several important characteristics, namely sensitivity, frequency response (coloration) and directional pick up pattern (polar diagram). Both sensitivity and frequency response are generally met by the electret microphone. The pick up pattern (or polar diagram) refers to the sensitivity and frequency response to sounds coming from different directions. The pick up patterns available are common to all microphones and are basically of four types:

Omnidirectional, which provides a uniform response in all directions and generally provides excellent coloration.

FIG. 8, which is intended to pick up sound from the front and the rear and which has good coloration at higher frequencies but poor coloration at low frequencies.

Cardioid, which is intended to pick up sound roughly from a half-circle and has good coloration at higher frequencies but poor coloration at low frequencies.

Shotgun, which is intended to pick up sound from an angle of say 60-120°, and which generally has bad coloration.

The shotgun response has a generally forward pick up pattern of between 60-120° of arc and the pick up pattern is highly distorted with the response tending towards omnidirectional at lower frequencies. This type of microphone is commonly used to record voices in noisy places, such as during crowded interviews and public or outside areas. It is unsuitable for professional recording, especially for music and cinematic products.

### SUMMARY OF THE INVENTION

The object of the present invention is to improve the performance of directional microphones.

The invention provides a directional microphone including:

a microphone array having at least two spaced-apart microphone elements for converting acoustic waves into electric audio signals; and

a processing section for receiving the electrical signals from the elements, the processing section including:

detecting means for detecting arrival of an acoustic wave at one of the elements; and direction discerning means for selectively allowing the electrical signals to pass to an output based on the time of travel of the acoustic waves from the said one of the elements to another of the elements.

By selectively allowing the signals to pass the output based on the time of travel from one of the elements to another of the elements, only signals travelling from a predetermined direction can be passed to the output, because if an acoustic wave of the same frequency travels from a different direction, the time of travel for the wave to move from the said one element to the other element will be different, thereby enabling that signal to be rejected. Thus, only signals from a predetermined direction that are processed by the microphone have their corresponding audio signals passed to the output.

Preferably the direction discerning means is for selectively allowing the electrical signals to pass to the output based on both the time of travel of the wave from the said one element to said another of the elements, and the frequency of the acoustic waves.

Preferably the detecting means comprises a zero-crossing detector for detecting zero-crossings of the audio signal detected by said one of the elements which audio signal corresponds to the acoustic wave received by the said one of the elements and converted into electrical signals by the said one of the elements.

Preferably the directional discerning means includes signal timing means for outputting a timing signal in response to the detecting means, a switch coupled to said another of the elements for receiving the signal timing signal, so that upon receipt of the signal timing signal the switch can be actuated to enable the electrical audio signals to pass from the said another of the elements to the output, and wherein the duration of the timing signal is dependent on a time band which defines the 3 dimensional angle of arc at which acoustic waves will be received by the microphone and processed by the microphone to provide the electrical signals at the output, and the duration of the timing signal defining a time period for travel of the acoustic wave from the said one of the elements to the said another of the elements.

Preferably the directional discerning means includes filter means for filtering the electrical signals to restrain the electrical signals to a predetermined bandwidth.

Preferably the signal timing means includes a pair of monostables connected to the detecting means, one of the monostables outputting a negative pulse of a first duration and the other of the monostables outputting a positive pulse of a second longer duration, the common period of the positive durations defining the duration of the timing signal.

Preferably the monostables are connected to an AND gate so that when the monostables both provide a high signal, the AND gate produces a high signal corresponding to the overlap of the high signal produced by the monostables to thereby provide the said timing signal of the required duration.

Preferably the AND gate is connected to a D-type flip-flop so that when the timing signal is received by the flip-flop and an electrical signal is received by the said another of the elements, the flip-flop is controlled to produce an output that both corresponds in polarity to th timing signal, and has a duration of just over one half wavelength of the electrical signals produced by the said another of the elements, the output of the flip-flop being connected to the switch to control the switch to enable the electrical signals produced by the said another of the elements to be supplied to the output.

Preferably a second filter substantially identical to the first filter is provided between the switch and the said another of the elements so that only frequencies in a predetermined band are transmitted to the switch.

Preferably a second zero-crossing detector is connected to the second filter for triggering the flip-flop when the acoustic wave is received at the said another of the elements so that at that time, the switch is actuated if the signal arrives within the time period set by the timing signal, so that the electrical signal produced by the said another of the elements is allowed to pass by the switch means to the output.

In one embodiment of the invention, the processing section includes a processing array comprised of a plurality of said detecting means and direction discerning means, each being for detecting and passing electrical signals corresponding to acoustic waves of predetermined frequency.

In this embodiment, the filter or filters of each respective processing section in the array provides a different bandwidth of frequencies across the desired width of the audio spectrum.

In one embodiment of the invention, said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

Preferably the plurality of forward elements are spaced from the rear element by different distances and by progressively larger distances and each of the elements are substantially in a straight line.

Preferably the directional discerning means includes control means for changing the duration of the timing signal to thereby change the 3-dimensional angle of arc in which acoustic signals can be received and processed to provide the electrical signals at the output.

Preferably the control means comprises a controller for controlling the monostables to change the timing of the overlap of signals from the monostables which produces the said timing signal.

The invention also provides a directional microphone including:

a microphone array including at least two microphone elements, each for converting an acoustic wave received by the microphone into electrical audio signals; and

processing means for receiving the audio electrical signals from the microphone elements and for allowing signals having a phase difference falling within a particular range of phase differences to be supplied to an output, the range of phase differences setting the 3-dimensional angle of arc of acoustic waves which can be received by the microphone and processed by th microphone to provide an output signal at the output.

Thus, by selecting the range of phase differences, the effective 3-dimensional angle of arc and therefore the directionality of the microphone can be controlled so that signals emanating within that range of arc are processed by the microphone to provide an output from the microphone.

In one embodiment, the processing means includes:

first circuit means for providing a first output indicative of an acoustic wave being detected by one of the elements;

second circuit means for providing a timing signal in response to the output of the first circuit means;

a third circuit means coupled to the other of the elements, the third circuit means including switch means for selectively switching audio signals produced by another of the elements to the output;

fourth circuit means for providing a second output indicative of the arrival of an acoustic wave at the said other of the elements;

a switch control circuit coupled to the second and fourth circuits for actuating the switch in response to the output from the fourth circuit and the timing signal so that during the duration of the timing signal, immediately after receipt of the second output signal, the audio signal from the said other of the elements is passed by the switch means to the output.

Preferably the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

Preferably the monostables are connected to an AND gate so that when the monostables both provide a high signal, the AND gate produces a high signal corresponding to the overlap of the high signals produced by the monostables to thereby provide the said timing signal of the required duration.

Preferably the AND gate is connected to the switch circuit which comprises a D-type flip-flop so that when both the timing signal and second output are received by the flip-flop, the flip-flop will produce an output corresponding in polarity to the timing signal, and having a duration of just over one half the wavelength of the electrical audio signal produced by said another of the elements, the output of the flip-flop being connected to the switch to control the switch to enable the electrical signals produced by the said other of the elements to be supplied to the output.

Preferably a second filter substantially identical to the first filter is provided between the third circuit and the said another of the elements so that only frequencies in a predetermined band are transmitted to the switch.

Preferably the fourth circuit is a zero-crossing detector for triggering the flip-flop when the acoustic wave is received at the said another of the elements so that at that time, the switch is actuated if the signal arrives within the time period set by the timing signal, so that the electrical signal produced by the said other of the elements is allowed to pass by the switch means to the output.

In one embodiment of the invention, the processing means includes a processing array comprised of a plurality of said detecting means and direction discerning means, each being for detecting and passing electrical signals corresponding to acoustic waves of predetermined frequency.

In this embodiment, the filter or filters of each direction discerning means in the array provides a different bandwidth of frequencies across the desired width of the audio spectrum.

In one embodiment of the invention, said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

Preferably the plurality of forward elements are spaced from the rear element by different distances and by progressively larger distances and each of the elements are substantially in a straight line.

Preferably the second circuit includes control means for changing the duration of the timing signal to thereby change the 3-dimensional angle of arc in which acoustic signals can be received and processed to provide the electrical signals at the output.

Preferably the control means comprises a controller for controlling the monostables to change the timing of the overlap of signals from the monostables which produces the said timing signal.

The invention still further provides a directional microphone including:

a microphone array having at least two microphone elements, each for converting an acoustic wave into electrical audio signals;

a first circuit coupled to a first of the elements for receiving the audio signals from a first of the elements and providing a first output indicative of receipt of an acoustic wave by the first element;

a second circuit for receiving the output from the first circuit and for producing a timing signal indicative of a predetermined time period to provide a window of opportunity for travel of the acoustic wave from the first element to the other of the elements;

a third circuit for receiving the output audio signal from another of the elements and providing a second output indicative of the receipt of the acoustic wave by the said other of the elements;

a fourth circuit connected to the second and third circuit for providing a switch control signal in response to the second output during the duration of the timing signal provided by the second circuit; and

switch means coupled to the said other of the elements for receiving the audio signal produced by the said other of the elements, and also coupled to the fourth circuit for receiving the switch control signal from the fourth circuit and for switching the audio signal from the said other of the elements to the output.

Preferably the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

Preferably the monostables are connected to an AND gate so that when the monostables both provide a high signal, the AND gate produces a high signal corresponding to the overlap of the high signal produced by the monostables to thereby provide the said timing signal of the required duration.

Preferably the fourth circuit is a D-type flip-flop and the AND gate is connected to the flip-flop so that when the timing signal is received by the flip-flop and an electrical signal is received by the said another of the elements, the flip-flop is controlled to produce an output that both corresponds in polarity to the timing signal, and has a duration of just over one half the wavelength of the electrical audio signal produced by the said other of the elements, the output of the flip-flop being connected to the switch to control the switch to enable the electrical signals produced by the said other of the elements to be supplied to the output.

Preferably the first circuit includes a first filter for limiting the audio signals to a predetermined frequency bandwidth of signals.

Preferably the third circuit has a second filter substantially identical to the first filter is provided between the switch means and the said other of the elements so that only frequencies in a predetermined band are transmitted to the switch.

Preferably the third circuit has a second zero-crossing detector connected to the second filter for triggering the flip-flop when the acoustic wave is received at the said other of the elements so that at that time, the switch is actuated if the signal arrives within the time period set by the timing signal, so that the electrical signal produced by the said other of the elements is allowed to pass by the switch means to the output.

In one embodiment of the invention, a processing array comprised of a plurality of said first circuit, second circuit, third circuit, fourth circuit and the switch means is provided.

In this embodiment, the filter or filters of each respective first circuit and third circuit in the array provides a different bandwidth of frequencies across the desired width of the audio spectrum.

In one embodiment of the invention, said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the rear element and to an audio mixer for mixing outputs from the processing arrays to provide an audio output signal.

Preferably the plurality of forward elements are spaced from the rear element by different distances and by progressively larger distances and each of the elements are substantially in a straight line.

Preferably the second circuit includes control means for changing the duration of the timing signal to thereby change the 3-dimensional angle of arc in which acoustic signals can be received and processed to provide the electrical signals at the output.

Preferably the control means comprises a controller for controlling the monostables to change the timing of the overlap of signals from the monostables which produces the said timing signal.

Preferably the first and second element are separated by a distance of less than one quarter of the wavelength of the shortest wavelength acoustic signal intended to be received by the first element.

Preferably each of the forward elements are spaced from the rear element by a distance of less than one quarter of the wavelength of the shortest wavelength intended to be received by those respective elements.

The invention also provides:

a processing section for a directional microphone which has a microphone array having at least two spaced apart microphone elements for converting acoustic waves into electrical audio signals;

the processing section having an input for receiving the electrical signals from the elements;

detecting means for detecting arrival of an acoustic wave at one of the elements; and

direction discerning means for selectively allowing the electrical signals to pass to an output based on the time of travel of the acoustic waves from said one of the elements to another of the elements.

The invention still further provides a processing section for a directional microphone which has a microphone array including at least two microphone elements, each for converting an acoustic wave received by the microphone into electrical audio signals, the processing section including:

input means for receiving the electrical audio signals from the microphone; and

processing means for allowing signals having a phase difference falling within a particular range of phase differences to be supplied to an output, the range of phase differences setting the 3-dimensional angle of arc of acoustic waves which can be received by the microphone and processed by the processing section to provide an output signal at the output.

The invention still further provides a processing section for a directional microphone including a microphone array having at least two microphone elements, each for converting an acoustic wave into electrical audio signals, the processing section including:

a first circuit coupled to a first of the elements for receiving the audio signals from a first of the elements and providing a first output indicative of receipt of an acoustic wave by the first element;

a second circuit for receiving the output from the first circuit and for producing a timing signal indicative of a predetermined time period to provide a window of opportunity for travel of the acoustic wave from the first element to the other of the elements;

a third circuit for receiving the output audio signal from another of the elements and providing a second output indicative of the receipt of the acoustic wave by the other of the elements;

a fourth circuit connected to the second and third circuits for providing a switch control signal in response to the second output during the duration of the timing signal provided by the second circuit; and

switch means coupled to the said other of the elements for receiving the audio signals produced by the said other of the elements, and also coupled to the fourth circuit for receiving the switch control signal from the fourth circuit for switching the audio signals from the said other of the elements to the output.

### BRIEF DESCRIPTION OF THE DRAWINGS

FIG. 1 is a diagram showing acoustic waves from a source impinging on a microphone according to one embodiment of the invention;

FIG. 2 shows the same diagram as FIG. 1, except in terms of an acoustic wave having peaks and troughs to enable the principle or preferred embodiment of the invention to be described;

FIG. 3 is a diagram similar to FIG. 2, except showing an acoustic wave arriving at the microphone from a different direction;

FIG. 4 is a diagram also similar to FIG. 2 showing the acoustic waves arriving from a direction perpendicular to the axis of the microphone;

FIG. 5 shows the phase relationship of acoustic waves impinging at various angles on the microphone according to the preferred embodiment of the invention;

FIG. 6 shows a view of a microphone according to a second embodiment of the invention;

FIG. 7 is a block diagram of the microphone according to one embodiment of the invention;

FIG. 7A is a graph showing timing signals;

FIG. 8 is a block diagram according to one embodiment of the invention;

FIG. 9 is a block diagram applicable to the embodiment of FIG. 6;

FIG. 10 shows an example of a polar diagram of the amplitude response of a microphone according to one embodiment of the invention;

FIG. 11 shows the embodiment of FIG. 7, including a modification of a noise reduction system and a control to select the degree of directionality of the microphone;

FIG. 12 shows a further development of one embodiment of the invention;

FIG. 13 is a block diagram of a second embodiment which utilises software controlled signal processing rather than hardware components, as used in the previous embodiment;

FIG. 13A is a block diagram of part of the system of FIG. 1;

FIG. 13B is a block diagram in accordance with a second software processing system;

FIG. 13C is a flow chart explaining operation of the embodiment of FIG. 13A;

FIG. 13D is a flow chart explaining operation of the embodiment of FIG. 13B;

FIG. 14 shows an example of a directional microphone according to one embodiment of the invention; and

FIG. 15 is a cross-sectional view of the embodiment of FIG. 14.

### DETAILED DESCRIPTION OF THE PREFERRED EMBODIMENTS

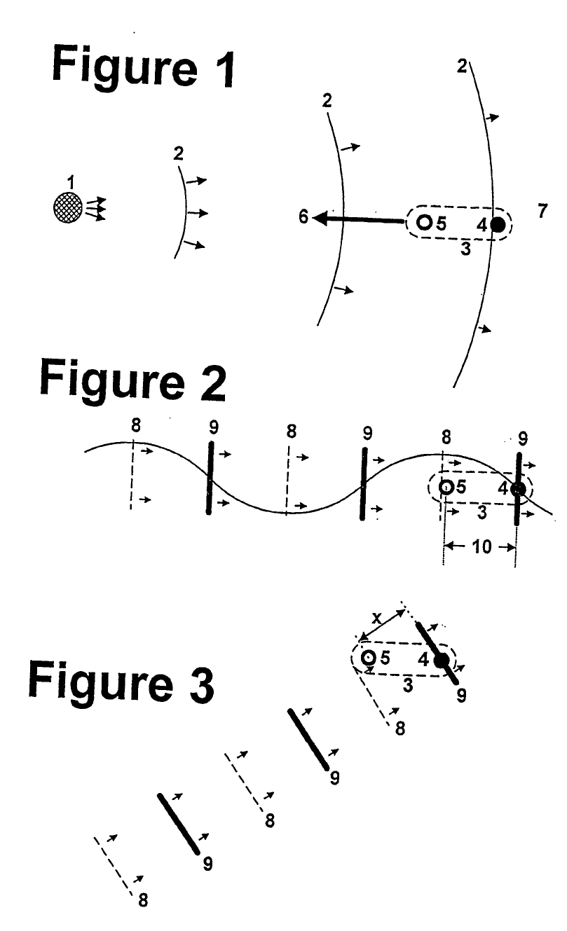

FIGS. 1 to 4 show acoustic waves impinging on a microphone according to one embodiment of the invention. The microphone is represented by mic-array 3 which comprises a plurality of microphone elements. In this embodiment, two microphone elements 4 and 5 are provided. The microphone elements may be in the form of any suitable transducer for converting acoustic waves to electrical audio signals such as electrostatic membranes or moving coil-type devices.

In FIG. 1, acoustic waves 2 emanating from a source 1 are received by the mic-array 3. The array 3 is arranged so that the axis of the mic-array 3, that is a line joining the elements 4 and 5, is parallel to the direction of travel of the waves 2. In other words, the microphone is pointed directly at the source 1 as shown by the arrow 6 which represents the directional axis of the microphone.

FIG. 2, is a diagram showing the acoustic waves impinging on the mic-array 3. The acoustic wave, as is well known, has peaks and troughs shown by dash lines 8 and also zero-crossings 9. In other words, the peaks show maximum amplitude in one direction, the troughs maximum amplitude in the opposite direction, and the zero-crossings 9 being of zero amplitude.

The distance between the elements 4 and 5 is an amount less than one quarter of the wavelength of the shortest wavelength which the microphone is intended to receive.

As is apparent from FIGS. 1 and 2, if the acoustic wave is travelling in the direction of the axis of the microphone, which axis is represented by the arrow 6, the distance a zero cross-over point needs to travel from the forward element 5 to the rear element 4 is shown by distance 10 in FIG. 2 which is the distance between the elements 4 and 5 in the direction of the axis 6.

FIG. 3 shows an example similar to FIG. 2 but where the acoustic wave is travelling at an angle to the microphone. In this example, the distance a zero-crossing point needs to travel from the forward element 5 to the rear element 4 is shown by distance X in FIG. 3, which is less than the distance 10 in FIG. 2.

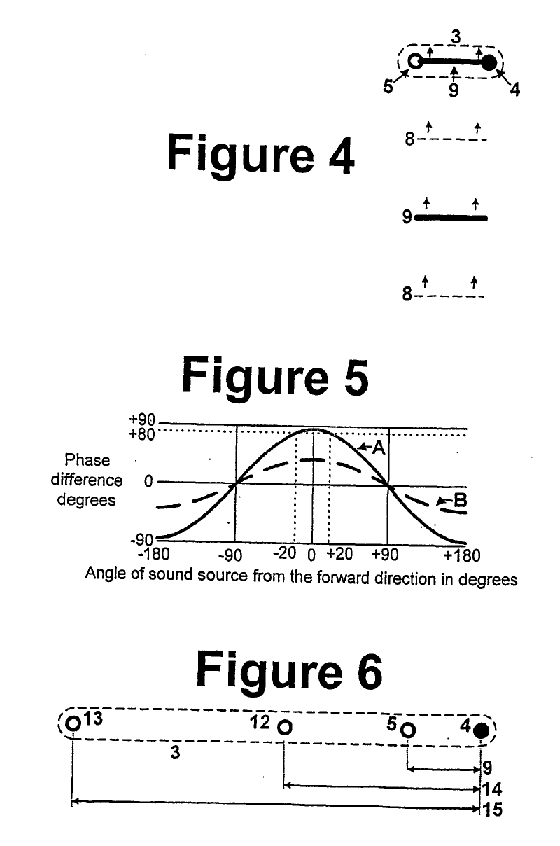

FIG. 4 effectively shows the case where the acoustic wave is travelling at a direction at right angles to the axis of the microphone. In this case, the distance the zero cross-over points travel from the forward element 5 to the rear element 4 is zero because the zero cross-over point, as shown by numeral 9 in FIG. 4, impinges on both elements 4 and 5 at the same time.

Thus, as the angle of impingement of the waves on the elements 4 and 5 changes from the situation in FIGS. 1 and 2 where the wave is travelling in the direction of the axis of the microphone, to a direction perpendicular to the microphone, as shown in FIG. 4, the distance the zero-crossing point needs to travel from the element 5 to the element 4 decreases. Thus, the time the zero-crossing point takes to travel from the element 5 to the element 4 also decreases for any given frequency because the speed of travel of the acoustic wave will be the same regardless of direction. As noted above, this is because the distance the acoustic wave needs to travel for the zero-crossing point to impinge first on the forward element 5 then on the rear element 4, decreases as the angle of the acoustic wave to the microphone axis increases from the situation in FIGS. 1 and 2 to the situation in FIG. 4. If it is assumed that the acoustic wave is emanating from behind the microphone, then the distance travelled from the forward element 5 to the rear element 4 is effectively a negative distance and the time taken a negative time, relative to the situation shown in FIGS. 1 to 4

The difference in distance which the zero cross-over point needs to travel from the forward element 5 to the rear element 4 can be expressed in terms of the phase of the wave. For example, in the situation in FIG. 2, the phase difference is effectively nearly 90° because the separation of the elements 4 and 5 is just slightly less than one quarter of the wavelength of the acoustic wave. This ensures the phase difference between the waves received at the detectors 4 and 5 will always be between 0° and 90°.

FIG. 5 shows the relationship between the phase difference and the angle at which the acoustic wave travels with respect to the axis 6 of the microphone. 30

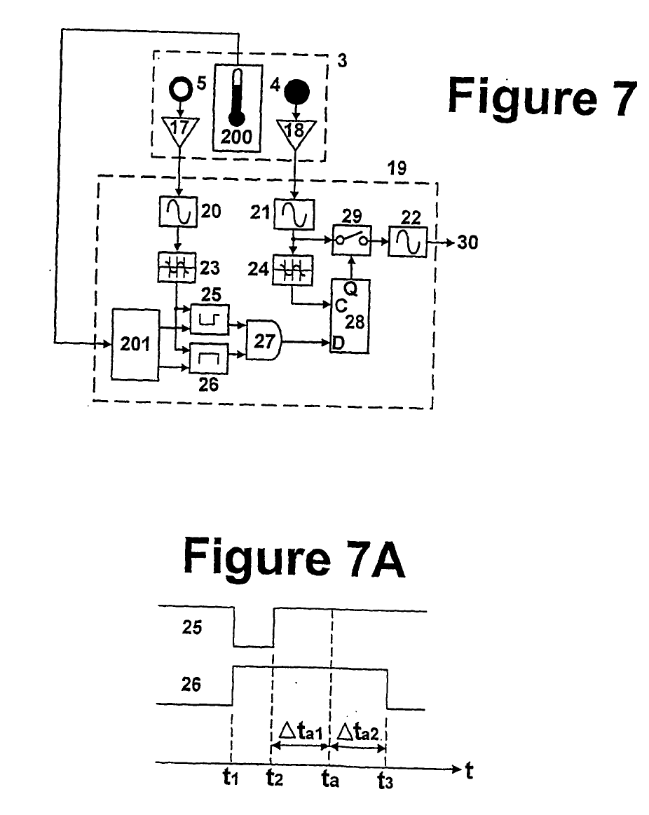

It can be seen from trace A in FIG. 5 that at zero angle, as is the case in FIGS. 1 and 2, the phase difference is nearly 90° as is represented in FIG. 2. At 90°, as is the case in FIG. 4, the phase difference is 0°, indicative of the fact that a zero-crossing point arrives at the elements 4 and 5 simultaneously. Thus, by selecting a suitable range of phase difference, a 3-dimensional angle of arc or, in other words, a forward aperture, of the microphone can be selected. For example, with reference to FIG. 5, if a phase difference range of between 80 and 900 is selected, as shown in FIG. 5, the 3-dimensional angle of arc will be, say from −20 to 20°. Thereby producing an effective directional angle of arc of the microphone of 40°. If the range is limited to nearly 90° then the effective angle of arc is 0°, meaning that only sound emanating in the direction of arrow 6 in FIGS. 1 and 2 can be processed by the microphone. The effective angle of arc therefore translates to the time difference between receipt of a zero-crossing point by the front element 5 and rear element 4. If a timing difference is provided which is exactly equal to the time an acoustic wave, in air at a given temperature, will travel from the forward element 5 to the rear element 4 such as the time ta, this would be equivalent to the 90° example referred to above, in which only radiation which is received from the direction of the axis 6 will be processed by the microphone. However, if the time is given a tolerance or range such as ta +Δta₂ or −Δta₁, then the range of angles from which sound can be received opens up. The greater the range, obviously the greater the angle. Thus, for very precise directionality, Δta₁ is very small, whereas for less precise and greater 3-dimensional angle of arc, Δta₁ is larger. This will be explained in more detail hereinafter with reference to FIG. 7A.

Trace A in FIG. 5 represents the situation of a wave shown in FIGS. 1 and 2 of a first frequency. The trace B shown in dotted lines in FIG. 5 shows the situation for an acoustic wave of larger wavelength or lower frequency. It can be seen that for the lower frequency signal B, the same concept applies and sounds can be limited to a particular direction by selecting a suitable phase difference angle to provide a desired 3-dimensional angle of arc which is to be received and processed by the microphone for that frequency.

FIG. 6 shows a second embodiment of the invention in which additional forward elements 12 and 13 are also included. Thus, in this embodiment, the microphone array 3 includes rear element 4, and forward element 5, 12 and 13. The distance to each element 5, 12 or 13 from the rear element 4 is represented by the arrows 9, 14 and 15 in FIG. 6. Preferably the distances increase proportionally as can be shown by the arrow 9, 14 and 15. The reason for the increased number of forward elements will be explained hereinafter.

FIG. 7 shows a block diagram according to the first embodiment of the invention. With reference to FIG. 7, the mic-array 3 is shown having the rear element 4 and the forward element 5. The elements 4 and 5 may be connected to amplifiers 17 and 18 for amplifying the electrical signal produced by the elements 4 and S.

The elements 4 and 5 are connected to a processing section 19. The processing section 19 comprises a first band-pass filter 20 which is connected to the element 5 via the amplifier 17 and a second identical filter 21 which is connected to the rear element 4 via the amplifier 18. The band-pass filter 20 and the band-pass filter 21 are narrow in order to select a narrow bandwidth of audio frequencies in response to the acoustic waves which are detected by the elements 4 and 5. Thus, only acoustic waves corresponding to the frequency of the narrow bandwidth of the filters 20 and 21 pass through the filters 0.20 and 21. The filter 20 is connected to a first zero-crossing detector 23. The detector 23 is connected to a pair of monostables 25 and 26. The monostable 25 produces a negative going pulse upon an output from the detector 23 when a zero-crossing of an acoustic wave corresponding to the zero-crossing of the electrical audio signal produced by the element 5 occurs at the element 5. The monostable 26 produces a longer going positive pulse upon receipt of an output from the detector 23 in response to the detection of a zero-crossing of an acoustic wave by the element 5. The outputs of the monostables 25 and 26 are connected to an AND gate 27. The AND gate 27 is connected to the D-input of a D-type flip-flop 28. Band-pass filter 21 is connected to a zero-crossing detector 24 and also to an electronic switch 29. The zero-crossing detector 24 is connected to the C-input of the flip-flop 28. Output Q of the flip-flop 28 is connected to the switch 29 in order to control the switch 29. The switch 29 is connected to a narrow band-pass filter 22 which is identical to the band-pass filters 20 and 21.

When an acoustic signal is detected by the forward element 5, the acoustic signal is converted into electronic form by the element 5 and passed by amplifier 17 to filter 20. If the acoustic signal is within the bandwidth of the filter 20, the signal is passed to the zero-crossing detector 23. As soon as the zero-crossing point is detected, the detector. 23 outputs a signal to the monostables 25 and 26. The receipt of the signals by the monostables 25 and 26 causes the monostables to output their positive and negative pulses.

As is best shown in FIG. 7A, the negative pulse from the monostable 25, which has a shorter duration than the positive pulse from the monostable 26, results in an overlap of a high signal at time t₃-t₂ which is supplied to the AND gate 27. The high signal which exists in the time period t₃-t₂ causes the output of the AND gate 27 to go high and this high signal is applied to input D of the flip-flop 28.

The time period t₃-t₂ represents the time range at which the acoustic signal can travel from the forward element 5 to the rear element 4 and still be accepted as being within the 3-dimensional angle of arc which will be accepted by the microphone as will be described hereinafter. As is shown in FIG. 7A, the time ta represents the time previously described at which 0° of angle is accepted (ie. only sound waves in the direction of the axis 6) whereas −Δta₁ and +Δta₂ provide the range of, for example, between −20 and 20°, giving 40° of 3 dimensional arc, which can be accepted by the microphone. Obviously, by making Δta₁ smaller, the angle of arc which is received by the microphone is reduced, therefore increasing the precision of the directionality of the microphone. The time between time t₁ at which the zero cross-over point is received by the detector 23 and the output supplied to the monostables 25 and 26 and time t₂ is representative of the time the acoustic wave takes to travel from the forward element 5 towards rear element 4 before the window of opportunity commences for receiving sound signals and processing those sound signals by the microphone. The time period t₃-t₂ is adjusted by changing the period Δta₁ whilst maintaining the time period Δta₂ substantially constant. The total period ta-t₁ is preferably always maintained proportional to the period t₂-t₁. The time t₂-t₁ is the part of the aperture which is not taking signals and t₃-t₂ which is Δta is the window of opportunity or time period in which signals will be received and supplied to the output. The time Δta₂, although shown as the same size as Δta₁ in FIG. 7A, will generally be a lot smaller and represents a degree of tolerance of componentry.

Thus, the same acoustic wave of same frequency which is received by element 4 and whose corresponding electrical audio signal passes through filter 21 also triggers the zero-crossing detector 24 so as to provide an output to input C of the flip-flop 28. When an input at C is received, status of the the input at D is transferred to output Q and if this is positive, as is the case in the time t₃-t₂ as shown in FIG. 7A, the output will be positive, thereby triggering the switch 29 to close the switch 29. Thus, the signal passing through the filter 21 can therefore pass through the switch 29 to the filter 22 and hence to output 30. Thus, the only signals which are output from the microphone are the signals at output 30 which are indicative of signals being received within the required 3-dimensional degree of arc of the microphone, thereby ensuring only the directional signals required to be selected and processed are in fact processed by the microphone and transmitted to the output for use.

The band-pass filter 22 performs a special role in filling small gaps which may occur due to switching on of the switch 29 in response to signals received by the monostables 25 and 26, AND gate 27 and flip-flop 28. Any filter has an inherent ability to ring or maintain its output for a small time period in a manner akin to the ringing of a bell. This effect is used to reconstruct missing parts of the signal that have been momentarily blocked out by rejection of signals from the microphone. Thus, the sound produced by the microphone is a continuous sound without any apparent discontinuities.

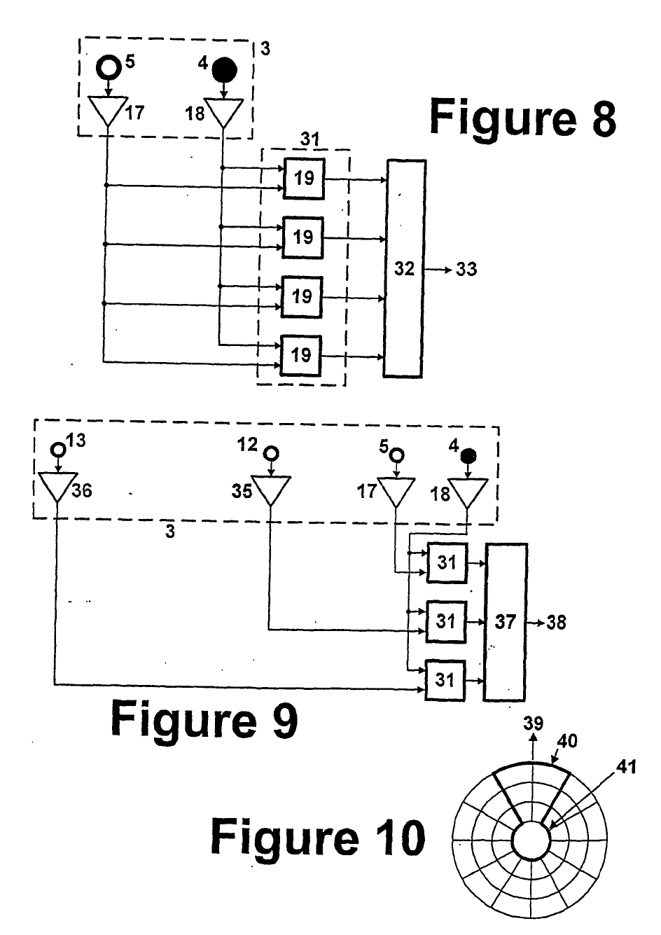

FIG. 8 shows a development to the embodiment of FIG. 7. In FIG. 7 only a single bandwidth, as presented by the bandwidth of filters 20, 21 and 22, is processed by the microphone obviously, in practice, a wide range of frequencies needs to be handled by the microphone and in order to achieve this, the processing circuitry 19 is effectively duplicated a plurality of times in signal processing array 31′. Each of the processors 19 shown in FIG. 8 is identical to the configuration shown with reference to FIG. 7, except that the bandwidth of the filters 20, 21 and 22, which were included in each of those processes, is different to provide, when accumulated, a wide bandwidth coverage. In the example in FIG. 8, only four processors 19 are shown in the array 31. However, in practice, a much larger number would be included. Thus, each of the processors 19 effectively handles a discreet bandwidth in the manner described with reference to FIG. 7 and the output of all of the processors 19 is supplied to audio mixer 32 which receives those outputs and mixes the outputs to provide a final output signal 33. Each of the processors 19 in FIG. 8 is provided with the monostables 25 and 26 as per the embodiment of FIG. 7, except that the output durations of the monostables 25 and 26 are different corresponding to the different frequencies which are to be passed by the filters in each of those processors 19.

FIG. 9 is a block diagram applicable to the embodiment of FIG. 6 in which three forward elements are provided and which are spaced from the rear element 4 by the distances 9, 14 and 15 as shown in FIG. 6. In this embodiment, the elements 4, 5, 12 and 13 are connected to amplifiers 18, 17, 35 and 36 and the output from the amplifiers is connected to processing arrays 31. As can be seen, the rear element 4 is connected to each of the processing circuits 0.31 and the elements 5, 12 and 13 to one of the processing elements 31.

The processing elements 31 are the same as the element 31 shown in FIG. 8 which is made up of a plurality of the processing circuits 19 in FIG. 7. These elements work in exactly the same fashion as the element 31 and the elements 19 described with reference to FIGS. 8 and 7. However, each array 31 will have a different Δta time period corresponding to the separation of the respective elements 5, 12 or 13 from the element 4. In this embodiment, each of the processing circuits 31 is intended to handle a different wavelength or frequency range. For example, the uppermost circuit 31 which is connected to element 5 would function in exactly the same fashion as the element 31 in FIG. 8 and handle relatively short wavelengths, the second circuit 31 which is connected to the element 12, which is separated from the rear element 4 by a much larger distance, would handle much longer wavelengths, and the bottom circuit 31 which is connected to the element 13 would handle still larger wavelengths. The circuits 31 are connected to mixer 37 to provide an output 38.

The use of multiple forward elements, as is the case in the embodiments of FIGS. 6 and 9, enables higher frequencies to be handled much more easily than the embodiment in which only one forward element is used because at lower sound frequencies, the phase differences become so small that the electronic discrimination of zero-crossings at a single distance between the rear element 4 and the front element 5 becomes unreliable. By using more forward elements, the lower sound frequencies or larger wavelengths can be much better handled because of the larger spacing between the rear element 4 and the respective forward element.

FIG. 10 shows a polar diagram of the 3-dimensional angle of arc which can be received by the microphone.

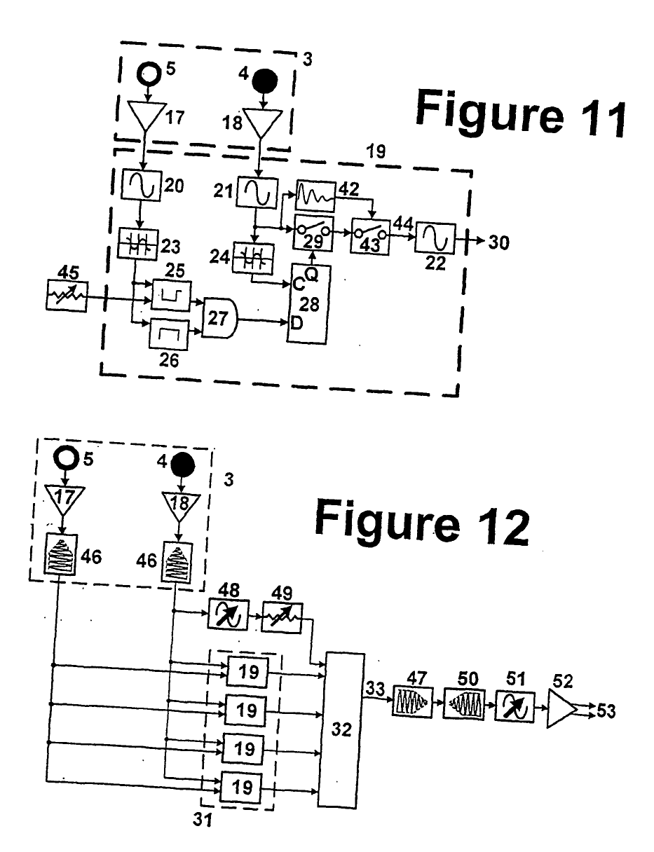

Obviously, only two dimensions are shown in the drawing, but it will be appreciated that by selecting the appropriate time duration between the times t₂ and t₃ in FIG. 7A, the 3-dimensional angle of arc which will be received and transmitted by the microphone can be selected. In the example shown in FIG. 10, the microphone has a forward axis 39 and a 3-dimensional degree of arc 40 which is received and processed by the microphone. Signals emanating in the region 41 falling outside the region 40 are not processed by the microphone and therefore not transmitted to the outputs for use. FIG. 11 shows a further modification to the embodiment of FIG. 7. In this embodiment, the processing section 19 includes a noise gate comprised of a low level signal detector 42 and electronic switch 43. Thus, low level signals received at the output 30 are detected by the detector 42 which opens switch 43 to thereby prevent the output signal 30 from being transmitted to final output 44.

This embodiment may also include a user-adjustable aperture control 45 which is connected to the monostables 25 and 26 to vary their timing, thus enabling a change in the forward aperture or 3-dimensional angle of arc (such as the arc 40 shown in FIG. 10) which is received and processed by the microphone. The control 45 effectively changes the time Δta₁ and therefore the time interval t₃-t₂ shown in FIG. 7A to change the 3-dimensional angle of arc which will be accepted and processed by the microphone 3. Thus, the degree of directionality of the microphone can be adjusted by control of the control 45.

Obviously, each of the processing sections 19 in the embodiments of FIGS. 8 and 9 can also include the modifications included in FIG. 11.

FIG. 12 shows a further development of the embodiment of FIG. 8. In FIG. 12, audio compressors 46 are coupled between the amplifiers 17 and 18 and the processing array 31. This improves noise reduction by a fixed level of compression to create high audio signal levels for the various audio signal processing stages, whereby any noise produced during the audio signal processing is reduced by the audio decompressor 47 with a fixed level of decompression that then restores the audio signals back to their correct form.

Another modification includes a us r-adjustable automatic gain control 50 to deliver a selected level of audio compression to the processed output at final output 53.

Another modification provides a user-adjustable ambience control whereby a low pass audio filter 48 is followed by a volume control 49, whose output feeds into the audio mixer 32.

Another modification provides a user-adjustable tone control 51 that allows for audio functions such as base control or treble control, and finally a further refinement provides a user-adjustable audio amplifier 52 which acts as a volume control that additionally provides a balanced processed audio output 53.

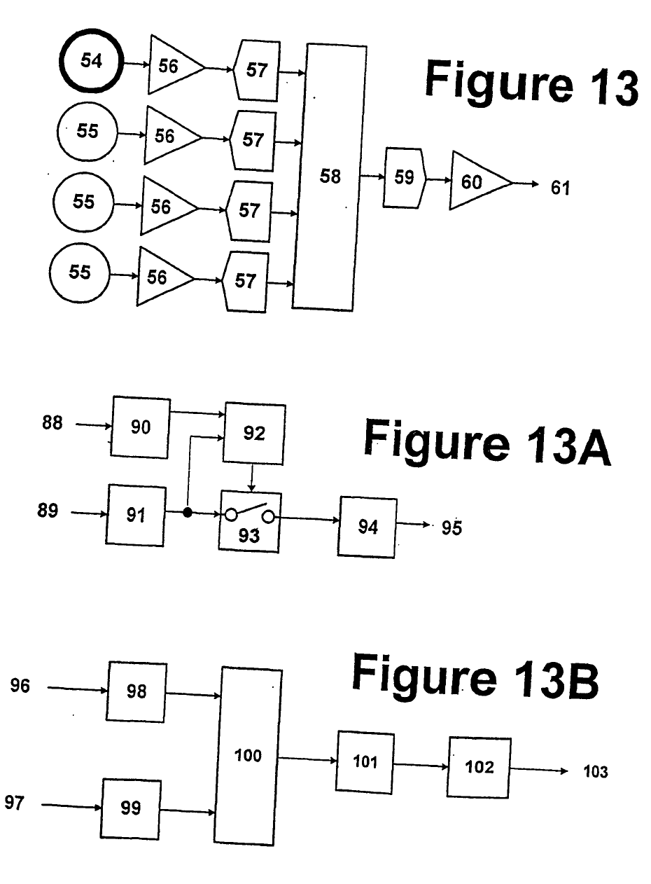

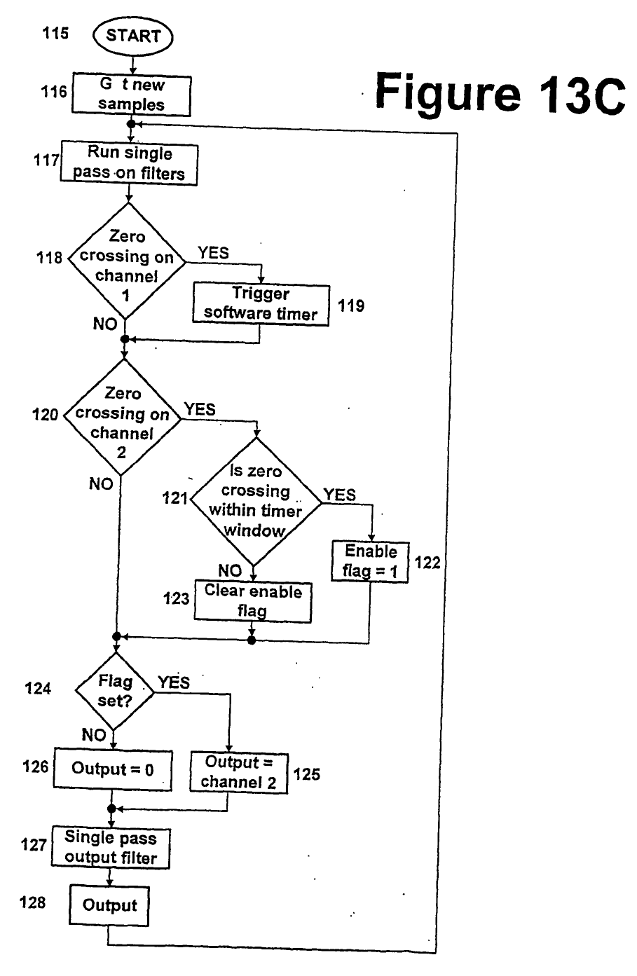

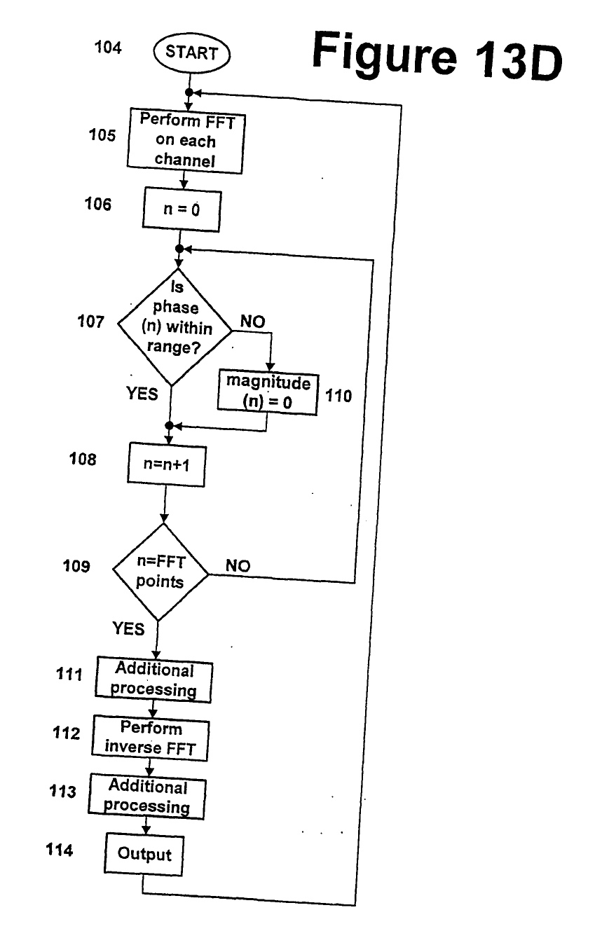

FIGS. 13, 13A, 13B, 13C and 13D are embodiments of the invention which comprise software control processing of the signals rather than processing of signals by hardware components as in the earlier embodiments.

With reference to FIG. 13, the processing system used in both embodiments is shown. In this embodiment, rear element 54 corresponds to rear element 4 previously described, and forward elements 55 (three in the example shown) correspond to elements 5, 12 and 13. The elements 54 to 55 are connected to amplifiers 56 and the output of the amplifiers 56 are each connected to analogue to digital converters 57. The analogue to digital converters are connected to a microprocessor 58 which performs all of the signal processing, as will be described hereinafter. The output of the processor 58 is connected to a digital to analogue converter 59 and the output of the converter 59 to an amplifier 60 to provide an amplified output 61.

FIG. 13A is an example of the processor 58 according to one software implemented embodiment and the blocks shown in this drawing represent processing protocols implemented by the processor 58. A plurality of the modules shown in FIG. 13A are included in the processor 58 and the modules include finite impulse response or infinite impulse response filters 90 and 91. The input to the filter 90 is from the element 54 and represented by reference 88 in FIG. 13A and the input from one of the other forward elements 55 is represented by input 89 to the filter 91. The filters 90 and 91 are connected to phase processor 90 which in turn controls switch 93. The switch 93 is connected to a further finite impulse response or infinite impulse response 94 to provide an output 95.

In FIG. 13B a second embodiment is shown in which inputs 96 and 97 which correspond to the output of element 54 and one of the forward elements 55 respectively, are each coupled to fast fourier transform processors 98 and 99. The fast fourier transform processors 98 and 99 are connected to phase processing section 100. The output of the section 100 is connected to an inverse fast fourier transform processor 101 and the output of processor 101 is connected to optional output processing circuitry 102 to provide an output 103.

With reference to FIG. 13C which shows the flow chart for operation of the software control processing of FIGS. 13 and 13A, it can be seen that the program starts at step 115 and at step 116 samples of the signals received by the processor 58 are obtained and the samples of the signals are passed through the filters 90 and 91 at step 117. At step 118, a decision is made as to whether a zero-crossing has occurred on channel 1, which corresponds to the signal received from one of the forward elements 55. If the answer is yes, the process steps to step 119 where a software controlled timer is triggered to set a time which is effectively the window of opportunity at which the audio signal can be received by the rear element 54. At step 120, the software looks for a zero-crossing on channel 2, which identifies the signal being received from the rear element 54. If the answer is yes, the process steps to step 121 where a determination is made whether that zero-crossing falls within the time window set by the trigger of the software timer. If the answer is yes, the program moves to step 122, which sets an enable flag to one. If the answer is no, the enable flag is cleared at step 123.

At step 124, a determination is made as to the setting of the flag and if the flag is set at one, the output of channel 2 is supplied as per step 125. If the answer is no, the output is set to zero so, in effect, zero output is supplied thereby blocking or eliminating the signal because it has not fallen within the time window determined at step 121. This effectively provides the function of the switch 93 shown in FIG. 13A. The signal is then passed through output filter 94 at step 127 and and that signal is outputted as identified by item 95 from the processor 58 of FIG. 13 and to the digital to analogue converter 59 shown in FIG. 13.

At step 128, the software controlled process then moves back to step 116 and a new sample of the signals provided at 88 and 89 in FIG. 13 from the forward element 55 and the rear element 54 are again processed in the manner described above.

Thus, it can be seen in the software implementation of the invention that the process works on the timing of the signal and the arrival of a signal within a predetermined window of opportunity at the rear element 54 and if this occurs, the signal is provided to the output of the processor 58 for conversion into digital form and then to amplifier 60 for amplification to provide the output 61.

FIG. 13D is a flow diagram explaining the implementation of the embodiment of FIG. 13B, which uses fast fourier transformation of the signals in order to determine which signals are to be supplied to the output. The process starts at step 104 and at step 105, fast fourier transformation is performed on both channels 96 and 97 which correspond to the rear element 54 and one of the forward elements 55. At step 105, the complex fast fourier transformation generates a complex number which is converted to polar rotation which gives a phase value and a magnitude. At stop 106, a sample of a first sample point of the transformed signals in each channel is made and the phase and amplitude of the sample point therefore obtained, and a determination is made as to whether the phase of those sample points are within a predetermined range. If the answer is no, the magnitude of the sample N is set to zero at step 110. If the answer is yes, the count of N is incremented by 1 at step 108, and at step 109, a determination is made as to whether all of the sample points of the fast fourier transform signals have been considered. If the answer is no, the process goes back to step 107 so that the next sample point is then considered. The sampling and determination of whether the phase is within the predetermined range continues to loop through steps 107 to 109 until all N sample points of the fast fourier transform signals have been processed in the manner described above. When it has been determined at step 109 that all of the sample points have been processed, the output of the fast fourier transform signal is supplied with the magnitude of the sample points which do not fall within the phase range being set to zero and the others which do fall within the range being unaltered.

At step 111, additional processing can be performed as per element 101 of FIG. 13B. This additional processing could include equalisation, noise cancellation, etc. in which sample points are further reduced to magnitude zero or otherwise altered in accordance with predetermined protocols. At step 112, an inverse fast fourier transform is performed and at step 113, additional processing can still be performed such as extra filtering, ambience adjustment, etc. and the output then supplied as output 103 in FIG. 13B, which would comprise the output of the processor 58 in this embodiment of the invention. That signal is received by the digital to analogue converter 59 and converted to analogue form for supply to the amplifier 60 to provide the output 61.

At step 114, the software routine simply returns to step 105 to continue the analysis of incoming signals from the rear element 54 and one of the forward elements 55.

Obviously, the directionality of the microphone according to the embodiments of FIGS. 13, 13A and 13B is set, in the case of FIG. 13A, by the trigger software timer and the duration of that timer, and in the embodiment of FIG. 13B, by the phase difference range set at step 107. These values can be set dependent on the frequency which is to be analysed.

As in the earlier embodiments, a number of the modules described with reference to FIGS. 13A and 13B would be included in the processor 58, with each of the modules receiving the output from element 54, the amplifier 56 and the analogue to digital converter 57 and also one of the outputs from one of the elements 55, its associated amplifier 56 and its associated analogue to digital converter 57.

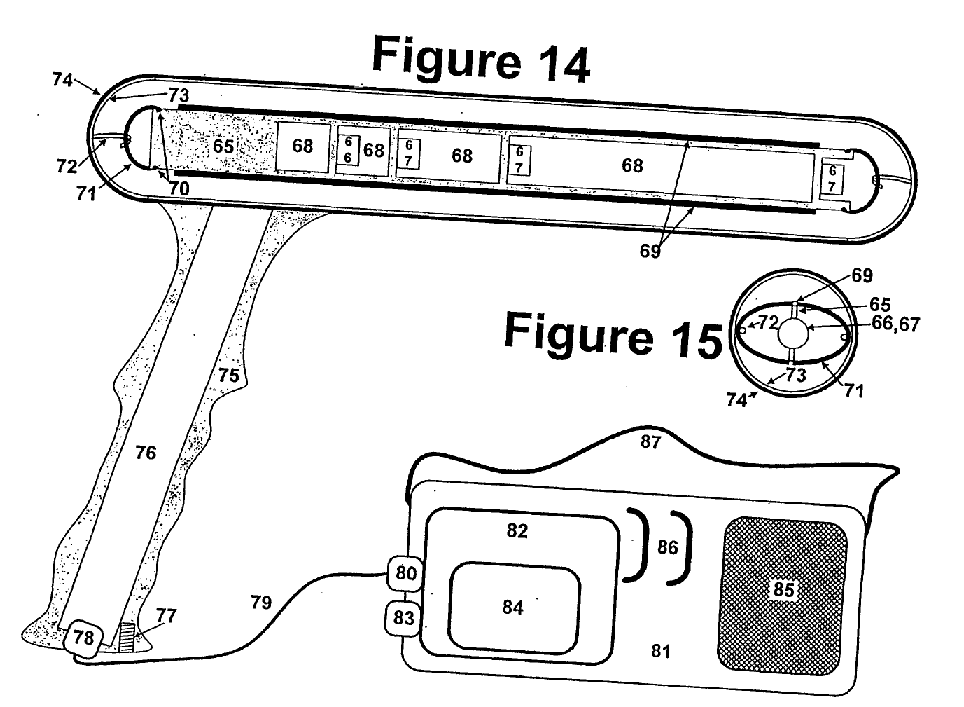

FIGS. 14 and 15 shows a practical embodiment of the invention in which the microphone houses a printed circuit board 65 containing rear element 66 and forward elements 67. The elements 66 and 67 are supported in cavity 68 and support tubing 69 may be provided to house the circuit board 65. The tubing 69 and circuit board 65 are supported on circuit board notches 70 by resilient O-rings 71 which mount onto hook 72 within protective cage 73. A cover 74 may cover the cage 73 and the protective cage 73 may mount on a hand grip 75. The hand grip 75 includes a cavity 76 and a screw mounting 77 for mounting a connector 78 which can join to a cable 79. The cable 79 can then join to connector 80 of a housing 81 in which the processing circuitry previously described can be included and which is exemplified by the block 82. An output connector 83 and a control panel 84 can also be mounted on the housing 81. The housing 81 can include a battery pack 85 and the housing 81 can be supported by a carry strap 87 or by belt clips 86.

In order to provide for temperature compensation which temperature may change the speed of acoustic waves travelling in the environment of the microphone, a thermal sensor 200 is mounted near the elements 4, 5, 12 and 13 (and corresponding elements 54 and 55) described with reference to FIG. 13) and output a temperature dependent signal to the processor 201 (see FIG. 7) to cause the time period Δta₁ set in monostables 25 and 26 (or the time count or phase range in processor 58) dependent on the temperature to therefore adjust for the different speed of an acoustic wave of a given frequency between the forward element and the rear element because of the change in temperature of the air. Thus, as temperature changes, the window of opportunity set by the time period or phase difference is automatically adjusted to compensate for the change in speed of the acoustic wave through the air at that temperature.

An important inclusion in all embodiments of the invention and which is described in FIGS. 14 and 15 is a temperature compensating element.

In further embodiments (not shown in the drawings), by implementing a feedback circuit on the filters and using a control circuit to control the amount of feedback, filter ringing can be adaptively controlled depending on the sound source.

Additionally the same system could be implemented on the fft version by peak detecting the frequency magnitude and using an exponential decay with a variable decay rate.

By monitoring the incoming signal, the control system can then modify the ringing to improve the sound quality.

Additionally by taking the mean value of the magnitude at a particular frequency and then use this to generate a “noise floor” at that frequency then the system can then eliminate any signals that are below this level, ie. Adaptive Environment Noise Processing.

1. A directional microphone including:
a microphone array having at least two spaced-apart microphone elements for converting acoustic waves into electric audio signals; and
a processing section for receiving the electrical signals from the elements, the processing section including:
detecting means for detecting arrival of an acoustic wave at one of the elements; and direction discerning means for selectively allowing the electrical signals to pass to an output based on the time of travel of the acoustic waves from the said one of the elements to another of the elements.

2. The microphone of claim 1 wherein the direction discerning means is for selectively allowing the electrical signals to pass to the output based on both the time of travel of the wave from the said one element to another of the elements, and the frequency of the acoustic waves.

3. The microphone of claim 1 wherein the detecting means comprises a zero-crossing detector for detecting zero-crossing of the audio signal detected by said one of the outputs which audio signal corresponds to the acoustic wave received by the said one of the elements and converted into electrical signals by the said one of the elements.

4. The microphone of claim 1 wherein the directional discerning means includes signal timing means for outputting a timing signal in response to the detecting means, a switch coupled to said another of the elements for receiving the signal timing signal, so that upon receipt of the signal timing signal the switch can be actuated to enable the electrical audio signals to pass from the said another of the elements to the output, and wherein the duration of the timing signal is dependent on a time band which defines the 3-dimensional angle of arc at which acoustic waves will be received by the microphone and processed by the microphone to provide the electrical signals at the output, and the duration of the timing signal defining a time period for travel of the acoustic wave from the said one of the elements to the said another of the elements.

5. The microphone of claim 2 wherein the directional discerning means includes filter means for filtering the electrical signals to restrain the electrical signals to a predetermined bandwidth.

6. The microphone of claim 4 wherein the signal timing means includes a pair of monostables connected to the detecting means, one of the monostables outputting a negative pulse of a first duration and the other of the monostables outputting a positive pulse of a second longer duration, the difference between the durations defining the duration of the timing signal.

7. The microphone of claim 6 wherein the monostables are connected to an AND gate so that when the monostables both provide a high signal, the AND gate produces a high signal corresponding to the overlap of the high signal produced by the monostables to thereby provide the said timing signal of the required duration.

8. The microphone of claim 7 wherein the AND gate is connected to a flip-flop so that when the timing signal is received by the flip-flop and an electrical signal is received by the said another of the elements, the flip-flop is controlled to produce an output that both corresponds in polarity to the timing signal, and has a duration of just over one half wavelength of th electric audio signal produced by the said another of the elements, the output of the flip-flop being connected to the switch to control the switch to enable the electrical signals produced by the said another element to be supplied to the output.

9. The microphone of claim 8 wherein a second filter substantially identical to the first filter is provided between the switch and the said another of the elements so that only frequencies in a predetermined band are transmitted to the switch.

10. The microphone of claim 9 wherein a second zero-crossing detector is connected to the second filter for triggering the flip-flop when the acoustic wave is received at the said another of the elements so that at that time, the switch is actuated if the signal arrives within the time period set by the timing signal, so that the electrical signal produced by the said another of the elements is allowed to pass by the switch means to the output.

11. The microphone of claim 10 wherein the processing section includes a processing array comprised of a plurality of said detecting means and direction discerning means, each being for detecting and passing electrical signals corresponding to acoustic waves of predetermined frequency.

12. The microphone of claim 11 wherein the filter or filters of each respective processing section in the array provides a different bandwidth of frequencies across the audio spectrum.

13. The microphone of claim 11 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

14. The microphone of claim 13 wherein the plurality of forward elements are spaced from the rear element by different distances and by progressively larger distances and each of the elements are substantially in a straight line.

15. The microphone of claim 1 wherein the directional discerning means includes control means for changing the duration of the timing signal to thereby change the 3 dimensional angle of arc in which acoustic signals can be received and processed to provide the electrical signals at the output.

16. The microphone of claim 1 including air temperature sensing means for sensing the temperature of air through which the acoustic waves travel and adjusting the time of travel for expected receipt of acoustic waves at said another of the elements, dependent on the air temperature.

17. The microphone of claim 1 wherein the processing section comprises a software controlled processor which provides the detecting means and the direction discerning means which detect arrival of an acoustic wave at one of the elements and selectively allow the electrical signals to pass to an output based on the time of travel of the acoustic wave from said one of the elements to another of the elements.

18. The directional microphone according to claim 17 wherein the processing section further includes an analogue to digital converter for converting analogue electrical signals into digital signals for supply to the processor.

19. The directional microphone according to claim 18 wherein the processor samples signals provided to the processor to determine zero-crossing points of signals received from the said one of the elements and said another of the elements and upon detection of a zero-crossing point of a signal from said one of the elements sets a timer, and the processor determines whether the zero-crossing of a signal from the said another of the elements has arrived within the time period set by the timer and whereupon if the zero-crossing point is within the time period supplies the signal from the said another of the elements to the output.

20. The directional microphone according to claim 18 wherein the electrical audio signals are processed by the processor by performing a fast fourier transformation on the signals, the phase of samples of signals being determined and a comparison made as to whether the phase is within a predetermined range, so that if the phase is within a predetermined range, this indicates the corresponding audio signal has travelled from the said one of the elements to said another of the elements within a predetermined time period, and if not within the range, setting the sample to magnitude zero so as to block or eliminate that sample, the processor also performing an inverse fourier transform on the signal after blocking or eliminating those samples which do not fall within the phase range and supplying those signals to the output.

21. The directional microphone according to claim 20 wherein additional signal processing is performed to enhance the signal before supply of the signal to the output.

22. The microphone of claim 15 wherein the control means comprises a controller for controlling the monostables to change the timing of the overlap of signals from the monostables which produces the said timing signal.

23. A directional microphone including:
a microphone array including at least two microphone elements, each for converting an acoustic wave received by the microphone into electrical audio signals; and
processing means for receiving the audio electrical signals from the microphone elements and for allowing said signals having a phase difference falling within a particular range of phase differences to be supplied to an output, the range of phase differences setting the 3-dimensional angle of arc of acoustic waves which can be received by the microphone and processed by the microphone to provide an output signal at the output.

24. The microphone of claim 23 wherein the processing means includes:
first circuit means for providing a first output indicative of an acoustic wave being detected by one of the elements;
second circuit means for providing a timing signal in response to the output of the first circuit means;
a third circuit means coupled to the other of the elements, the third circuit means including switch means for selectively switching audio signals produced by the another of the elements to the output;
fourth circuit means for providing a second output indicative of the arrival of an acoustic wave at the said other of the elements;
a switch control circuit coupled to the second and fourth circuits for actuating the switch in response to the output from the fourth circuit and the timing signal so that during the duration of the timing signal, immediately after receipt of the second output signal, the audio signal from the said another of the elements is passed by the switch means to the output.

25. The microphone of claim 24 wherein the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

26. The microphone of claim 24 wherein the monostables are connected to an AND gate so that when the monostables both provide a high signal, the AND gate produces a high signal corresponding to the overlap of the high signal produced by the monostables to thereby provide the said timing signal of the required duration.

27. The microphone of claim 26 wherein the AND gate is connected to the switch control circuit which comprises a D-type flip-flop so that when the timing signal and second output are received by the flip-flop, the flip-flop will produce an output corresponding in polarity to the timing signal, and having a duration of just over one half the wavelength of the electrical audio signal produced by the said other of the elements, the output of the flip-flop being connected to the switch to control the switch to enable the electrical signals produced by the said other of the elements to be supplied to the output.

28. The microphone of claim 27 wherein a second filter substantially identical to the first filter is provided between the third circuit and the said other of the elements so that only frequencies in a predetermined band are transmitted to the switch.

29. The microphone of claim 24 wherein the fourth circuit is a zero-crossing detector for triggering the flip-flop when the acoustic wave is received at the said another of the elements so that at that time, the switch is actuated if the signal arrives within the time period set by the timing signal, so that the electrical signal produced by the said other of the elements is allowed to pass by the switch means to the output.

30. The microphone of claim 27 wherein the processing means includes a processing array comprised of a plurality of said detecting means and direction discerning means, each being for detecting and passing electrical signals corresponding to acoustic waves of predetermined frequency.

31. The microphone of claim 30 wherein the filter or filters of each direction discerning means in the array provides a different bandwidth of frequencies across the desired width of the audio spectrum.

32. The microphone of claim 30 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

33. The microphone of claim 32 wherein the plurality of forward elements are spaced from the rear element by different distances and by progressively larger distances and each of the elements are substantially in a straight line.

34. The microphone of claim 24 wherein the second circuit includes control means for changing the duration of the timing signal to thereby change the 3-dimensional angle of arc in which acoustic signals can be received and processed to provide the electrical signals at the output.

35. The microphone of claim 28 wherein the control means comprises a controller for controlling the monostables to change the timing of the overlap of signals from the monostables which produces the said timing signal.

36. The microphone of claim 23 including air temperature sensing means for sensing the temperature of air through which the acoustic waves travel and adjusting the time of travel for expected receipt of acoustic waves at said another of the elements, dependent on the air temperature.

37. The microphone of claim 1 wherein the processing section comprises a software controlled processor which selectively allow the electrical signals to pass to an output based on the time of travel of the acoustic wave from said one of the elements to another of the elements and thereby being indicative of phase difference.

38. The directional microphone according to claim 37 wherein the processing section further includes an analogue to digital converter for converting analogue electrical signals into digital signals for supply to the processor.

39. The directional microphone according to claim 38 wherein the processor samples signals provided to the processor to determine zero-crossing points of signals received from the said one of the elements and said another of the elements and upon detection of a zero-crossing point of a signal from said one of the elements sets a timer, and the processor determines whether the zero-crossing of a signal from the said another of the elements has arrived within the time period set by the timer and whereupon if the zero-crossing point is within the time period supplies the signal from the said another of the elements to the output.

40. The directional microphone according to claim 38 wherein the electrical audio signals are processed by the processor by performing a fast fourier transformation on the signals, the phase of samples of the signals being determined and a comparison made as to whether the phase is within a predetermined range, and if not within the range, setting the sample-to magnitude zero so as to block or eliminate that sample, the processor also performing an inverse fourier transform on the signal after blocking or eliminating those samples which do not fall within the phase range and supplying those signals to the output.

41. The directional microphone according to claim 40 wherein additional signal processing is performed to enhance the signal before supply of the signal to the output.

42. A directional microphone including:
a microphone array having at least two microphone elements, each for converting an acoustic wave into electrical audio signals;
a first circuit coupled to a first of the elements for receiving the audio signals from a first of the elements and providing a first output indicative of receipt of an acoustic wave by the first element;
a second circuit for receiving the output from the first circuit and for producing a timing signal indicative of a predetermined time period to provide a window of opportunity for travel of the acoustic wave from the first element to the other of the elements;
a third circuit for receiving the output audio signal from the other of the elements and providing a second output indicative of the receipt of the acoustic wave by the said other of the elements;
a fourth circuit connected to the second and third circuit for providing a switch control signal in response to the second output during the duration of the timing signal provided by the second circuit; and
switch means coupled to the said other of the elements for receiving the audio signal produced by the said other of the elements, and also coupled to the fourth circuit for receiving the switch control signal from the fourth circuit and for switching the audio signal from the said other of the elements to the output.

43. The microphone of claim 42 wherein the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

44. The microphone of claim 43 wherein the monostables are connected to an AND gate so that when the monostables both provide a high signal, the AND gate produces a high signal corresponding to the overlap of the high signal produced by the monostables to thereby provide the said timing signal of the required duration.

45. The microphone of claim 44 wherein the fourth circuit is a D-type flip-flop and the AND gate is connected to the flip-flop so that when the timing signal is received by the flip-flop and an electrical signal is received by the said another of the elements, the flip-flop is controlled to produce an output that both corresponds in polarity to the timing signal, and has a duration of just over one half the wavelength of the electrical audio signal produced by the said other of the elements, the output of the flip-flop being connected to the switch to control the switch to enable the electrical signals produced by the said other of the elements to be supplied to the output.

46. The microphone of claim 42 wherein the first circuit includes a first filter for limiting the audio signals to a predetermined frequency bandwidth of signals.

47. The microphone of claim 46 wherein the third circuit has a second filter substantially identical to the first filter is provided between the switch means and the said another of the elements so that only frequencies in a predetermined band are transmitted to the switch.

48. The microphone of claim 42 wherein the third circuit has a second zero-crossing detector connected to the second filter for triggering the flip-flop when the acoustic wave is received at the said other of the elements so that at that time, the switch is actuated if the signal arrives within the time period set by the timing signal, so that the electrical signal produced by the said other of the elements is allowed to pass by the switch means to the output.

49. The microphone of claim 42 wherein the microphone includes a processing array comprised of a plurality of said first circuit, second circuit, third circuit, fourth circuit and th switch means is provided.

50. The microphone of claim 49 wherein the first and second circuits include filters and the filters of each respective first circuit and third circuit in the array provides a different bandwidth of frequencies across the desired width of the audio spectrum.

51. The microphone of claim 50 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the rear element and to an audio mixer for mixing outputs from the processing arrays to provide an audio output signal.

52. The microphone of claim 51 wherein the plurality of forward elements are spaced from the rear element by different distances and by progressively larger distances and each of the elements are substantially in a straight line.

53. The microphone of claim 42 wherein the second circuit includes control means for changing the duration of the timing signal to thereby change the 3-dimensional angle of arc in which acoustic signals can be received and processed to provide the electrical signals at the output.

54. The microphone of claim 53 wherein the control means comprises a controller for controlling the monostables to change the timing of the overlap of signals from the monostables which produces the said timing signal.

55. The microphone of claim 42 wherein the first and second element are separated by a distance of less than one quarter of the wavelength of the shortest wavelength acoustic signal intended to be received by the first element.

56. The microphone of claim 51 wherein each of the forward elements are spaced from the rear element by a distance of less than 14 of the wavelength of the shortest wavelength intended to be received by those respective elements.

57. A processing section for a directional microphone which has a microphone array having at least two spaced apart microphone elements for converting acoustic waves into electrical audio signals;
the processing section having an input for receiving the electrical signals from the elements;
detecting means for detecting arrival of an acoustic wave at one of the elements; and
direction discerning means for selectively allowing the electrical signals to pass to an output based on the time of travel of the acoustic waves from said one of the elements to another of the elements.

58. The processing section of claim 57 wherein the direction discerning means is for selectively allowing the electrical signals to pass to the output based on both the time of travel of the wave from the said one element to said another of the elements, and the frequency of the acoustic waves.

59. The processing section of claim 57 wherein the detecting means comprises a zero-crossing detector for detecting zero-crossing of the audio signal detected by said one of the elements which audio signal corresponds to the acoustic wave received by the said one of the elements and converted into electrical signals by the said one of the elements.

60. The processing section of claim 57 wherein the directional discerning means includes signal timing means for outputting a timing signal in response to the detecting means, a switch coupled to said another of the elements for receiving the signal timing signal, so that upon receipt of the signal timing signal the switch can be actuated to enable the electrical audio signals to pass from the said another of the elements to the output, and wherein the duration of the timing signal is dependent on a time band which defines the 3-dimensional angle of arc at which acoustic waves will be received by the microphone and processed by the microphone to provide the electrical signals at the output, and the duration of the timing signal defining a time period for travel of the acoustic wave from the said one of the elements to the said another of the elements.

61. The processing section of claim 58 wherein the directional discerning means includes filter means for filtering the electrical signals to restrain the electrical signals to a predetermined bandwidth.

62. The processing section of claim 60 wherein the signal timing means includes a pair of monostables connected to the detecting means, one of the monostables outputting a negative pulse of a first duration and the other of the monostables outputting a positive pulse of a second longer duration, the common period of the positive durations defining the duration of the timing signal.

63. The processing section of claim 62 wherein the monostables are connected to an AND gate so that when the monostables both provide a high signal, the AND gate produces a high signal corresponding to the overlap of the high signal produced by the monostables to thereby provide the said timing signal of the required duration.

64. The processing section of claim 63 wherein the AND gate is connected to a D-type flip-flop so that when the timing signal is received by the flip-flop and an electrical signal is received by the said another of the elements, the flip-flop is controlled to produce an output that both corresponds in polarity to the timing signal, and has a duration of just over one half the wavelength of the electrical signals produced by the said another of the elements, the output of the flip-flop being connected to the switch to control the switch to enable the electrical signals produced by the said another of the elements to be supplied to the output.

65. The processing section of claim 64 wherein a second filter substantially identical to the first filter is provided between the switch and the said another of the elements so that only frequencies in a predetermined band are transmitted to the switch.

66. The processing section of claim 65 wherein a second zero-crossing detector is connected to the second filter for triggering the flip-flop when the acoustic wave is received at the said another of the elements so that at that time, the switch is actuated if the signal arrives within the time period set by the timing signal, so that the electrical signal produced by the said another of the elements is allowed to pass by the switch means to the output.

67. The processing section of claim 66 wherein the processing section includes a processing array comprised of a plurality of said detecting means and direction discerning means, each being for detecting and passing electrical signals corresponding to acoustic waves of predetermined frequency.

68. The processing section of claim 67 wherein the filter or filters of each respective processing section in the array provides a different bandwidth of frequencies across the desired width of the audio spectrum.

69. The processing section of claim 67 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

70. The processing section of claim 69 wherein the plurality of forward elements are spaced from the rear element by different distances and by progressively larger distances and each of the elements are substantially in a straight line.

71. The processing section of claim 57 wherein the directional discerning means includes control means for changing the duration of the timing signal to thereby change the 3-dimensional angle of arc in which acoustic signals can be received and processed to provide the electrical signals at the output.

72. The microphone of claim 57 including air temperature sensing means for sensing the temperature of air through which the acoustic waves travel and adjusting the time of travel for expected receipt of acoustic waves at said another of the elements, dependent on the air temperature.

73. The microphone of claim 57 wherein the processing section comprises a software controlled processor which provides the detecting means and the direction discerning means which detect arrival of an acoustic wave at one of the elements and selectively allow the electrical signals to pass to an output based on the time of travel of the acoustic wave from said one of the elements to another of the elements.

74. The directional microphone according to claim 73 wherein the processing section further includes an analogue to digital converter for converting analogue electrical signals into digital signals for supply to the processor.

75. The directional microphone according to claim 73 wherein the processor samples signals provided to the processor to determine zero-crossing points of signals received from the said one of the elements and said another of the elements and upon detection of a zero-crossing point of a signal from said one of the elements sets a timer, and the processor determines whether the zero-crossing of a signal from the another of the elements has arrived within the time period set by the timer and whereupon if the zero-crossing point is within the time period supplies the signal from the said another of the elements to the output.

76. The directional microphone according to claim 73 wherein the electrical audio signals are processed by the processor by performing a fast fourier transformation on the signals, the phase of samples of signals being determined and a comparison made as to whether the phase is within a predetermined range, so that if the phase is within a predetermined range, this indicates the corresponding audio signal has travelled from the said one of the elements to said another of the elements within a predetermined time period, and if not within the range, setting the sample to magnitude zero so as to block or eliminate that sample, the processor also performing an inverse fourier transform on the signal after blocking or eliminating those samples which do not fall within the phase range and supplying those signals to the output.

77. The directional microphone according to claim 76 wherein additional signal processing is performed to enhance the signal before supply of the signal to the output.

78. A processing section for a directional microphone which has a microphone array including at least two microphone elements, each for converting an acoustic wave received by the microphone into electrical audio signals, the processing section including:
input means for receiving the electrical audio signals from the microphone; and
processing means for allowing signals having a phase difference falling within a particular range of phase differences including the case of zero phase difference to be supplied to an output, the range of phase differences setting the 3-dimensional angle of arc of acoustic waves which can be received by the microphone and processed by the processing section to provide an output signal at the output.

79. The processing section of claim 78 wherein the processing means includes:
first circuit means for providing a first output indicative of an acoustic wave being detected by one of the elements;
second circuit means for providing a timing signal in response to the output of the first circuit means;
a third circuit means coupled to the other of the elements, the third circuit means including switch means for selectively switching audio signals produced by the said other of the elements to the output;
a fourth circuit means for providing a second output indicative of the arrival of an acoustic wave at the said other of the elements;
a switch control circuit coupled to the second and fourth circuits for actuating the switch in response to the output from the fourth circuit and the timing signal so that during the duration of the timing signal, immediately after receipt of the second output signal, the audio signal from the said other of the elements is passed by the switch means to the output.

80. The processing section of claim 79 wherein the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

81. The processing section of claim 80 wherein the monostables are connected to an AND gate so that when the monostables both provide a high signal, the AND gate produces a high signal corresponding to the overlap of the high signals produced by the monostables to thereby provide the said timing signal of the required duration.

82. The processing section of claim 81 wherein the AND gate is connected to the switch circuit which comprises a D-type flip-flop so that when both the timing signal and second output are received by the flip-flop, the flip-flop will produce an output corresponding in polarity to the timing signal, and having a duration of just over one wavelength of the electrical audio signal produced by the said other of the elements, the output of the flip-flop being connected to the switch to control the switch to enable the electrical signals produced by the said other of the elements to be supplied to the output.

83. The processing section of claim 82 wherein a second filter substantially identical to the first filter is provided between the third circuit and the said other of the elements so that only frequencies in a predetermined band are transmitted to the switch.

84. The processing section of claim 79 wherein the fourth circuit is a zero-crossing detector for triggering the flip-flop when the acoustic wave is received at the said other of the elements so that at that time, the switch is actuated if the signal arrives within the time period set by the timing signal, so that the electrical signal produced by the said other of the elements is allowed to pass by the switch means to the output.

85. The processing section of claim 84 wherein the processing means includes a processing array comprised of a plurality of said detecting means and direction discerning means, each being for detecting and passing electrical signals corresponding to acoustic waves of predetermined frequency.

86. The processing section of claim 85 wherein the filter or filters of each direction discerning means in the array provides a different bandwidth of frequencies across the desired width of the audio spectrum.

87. The processing section of claim 86 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the said rear element and to an audio mixer for mixing outputs from the processing arrays to provide an audio output signal.

88. The processing section of claim 87 wherein the plurality of forward elements are spaced from the rear element by different distances and by progressively larger distances and each of the elements are substantially in a straight line.

89. The processing section of claim 79 wherein the second circuit includes control means for changing the duration of the timing signal to thereby change the 3 dimensional angle of arc in which acoustic signals can be received and processed to provide the electrical signals at the output.

90. The processing section of claim 89 wherein the control means comprises a controller for controlling the monostables to change the timing of the overlap of signals from the monostables which produces the said timing signal.

91. The processing section of claim 78 including air temperature sensing means for sensing the temperature of air through which the acoustic waves travel and adjusting the time of travel for expected receipt of acoustic waves at said another of the elements dependent on the air temperature.

92. The processing section of claim 1 wherein the processing section comprises a software controlled processor which selectively allow the electrical signals to pass to an output based on the time of travel of the acoustic wave from said one of the elements to another of the elements and thereby being indicative of phase difference.

93. The processing section according to claim 78 wherein the processing section further includes an analogue to digital converter for converting analogue electrical signals into digital signals for supply to the processor.

94. The processing section according to claim 92 wherein the processor samples signals provided to the processor to determine zero-crossing points of signals received from the said one of the elements and said another of the elements and upon detection of a zero-crossing point of a signal from said one of the elements sets a timer, and the processor determines whether the zero-crossing of a signal from said another of the elements has arrived within the time period set by the timer and whereupon if the zero-crossing point is within the time period supplies the signal from the said another of the elements to the output.

95. The processing section according to claim 92 wherein the electrical audio signals are processed by the processor by performing a fast fourier transformation on the signals, the phase of samples of the signals being determined and a comparison made as to whether the phase is within a predetermined range, and if not within the range, setting the sample to magnitude zero so as to block or eliminate that sample, the processor also performing an inverse fourier transform on the signal after blocking or eliminating those samples which do not fall within the phase range and supplying those signals to the output.

96. The processing section according to claim 95 wherein additional signal processing is performed to enhance the signal before supply of the signal to the output.

97. A processing section for a directional microphone including a microphone array having at least two microphone elements, each for converting an acoustic wave into electrical audio signals, the processing section including:
a first circuit coupled to a first of the elements for receiving the audio signals from a first of the elements and providing a first output indicative of receipt of an acoustic wave by the first element;
a second circuit for receiving the output from the first circuit and for producing a timing signal indicative of a predetermined time period to provide a window of opportunity for travel of the acoustic wave from the first element to the other of the elements;
a third circuit for receiving the output audio signal from the other of the elements and providing a second output indicative of the receipt of the acoustic wave by the other of the elements;
a fourth circuit connected to the second and third circuits for providing a switch control signal in response to the second output during the duration of the timing signal provided by the second circuit; and
switch means coupled to the said other of the elements for receiving the audio signals produced by the said other of the elements, and also coupled to the fourth circuit for receiving the switch control signal from the fourth circuit for switching the audio signals from the other of the elements to the output.

98. The processing section of claim 97 wherein the second circuit includes a pair of monostables connected to the detecting means, one of the monostables outputting a negative pulse of a first duration and the other of the monostables outputting a positive pulse of a second longer duration, the common period of the positive durations defining the duration of the timing signal.

99. The processing section of claim 98 wherein the monostables are connected to an AND gate so that when the monostables both provide a high signal, the AND gate produces a high signal corresponding to the overlap of the high signal produced by the monostables to thereby provide the said timing signal of the required duration in the form of a delayed high signal of a predetermined duration.

100. The processing section of claim 99 wherein the fourth circuit is a D-type flip-flop and the AND gate is connected to the flip-flop so that when the timing signal is received by the flip-flop and an electrical signal is received by the said another of the elements, the flip-flop is controlled to produce an output that both corresponds in polarity to the timing signal, and has a duration just over one half the wavelength of the electrical audio signal produced by the said other of the elements, the output of the flip-flop being connected to the switch to control the switch to enable the electrical signals produced by the said other of the elements to be supplied to the output.

101. The processing section of claim 97 wherein the first circuit includes a first filter for limiting the audio signals to a predetermined frequency bandwidth of signals.

102. The processing section of claim 101 wherein the third circuit has a second filter substantially identical to the first filter is provided between the switch means and the said other of the elements so that only frequencies in a predetermined band are transmitted to the switch.

103. The processing section of claim 97 wherein the third circuit has a second zero-crossing detector connected to the second filter for triggering the flip-flop when the acoustic wave is received at the said other of the elements so that at that time, the switch is actuated if the signal arrives within the time period set by the timing signal, so that the electrical signal produced by the said other of the elements is allowed to pass by the switch means to the output.

104. The processing section of claim 97 wherein the microphone includes a processing array comprised of a plurality of said first circuit, second circuit, third circuit, fourth circuit and the switch means is provided.

105. The processing section of claim 104 wherein the first and second circuits include filters and the filters of each respective first circuit and third circuit in the array provides a different bandwidth of frequencies across the desired width of the audio spectrum.

106. The processing section of claim 105 wherein said one of the elements is one of a plurality of elements which comprise forward elements and said another of the elements comprises a rear element, the microphone having a plurality of said processing arrays and each of the forward elements being connected to a respective said processing array, and each of the processing arrays being connected both to the rear element and to an audio mixer for mixing outputs from the processing arrays to provide an audio output signal.

107. The processing section of claim 106 wherein the plurality of forward elements are spaced from the rear element by different distances and by progressively larger distances and each of the elements are substantially in a straight line.

108. The processing section of claim 97 wherein the second circuit includes control means for changing the duration of the timing signal to thereby change the 3 dimensional angle of arc in which acoustic signals can be received and processed to provide the electrical signals at the output.

109. The processing section of claim 108 wherein the control means comprises a controller for controlling the monostables to change the timing of the overlap of signals from the monostables which produces the said timing signal.

110. The processing section of claim 97 wherein the first and second element are separated by a distance of less than one quarter of the wavelength of the shortest wavelength acoustic signal intended to be received by the first element.

111. The processing section of claim 110 wherein each of the forward elements are spaced from the rear element by a distance of less than one quarter of the wavelength of the shortest wavelength intended to be received by those respective elements.

112. A directional microphone including:
a first microphone element;
at least one second microphone element spaced from the first element;
temperature sensing means for sensing air temperature in the vicinity of the elements; and
wherein the output of the elements can be processed to determine the directionality of acoustic waves received by the microphone based on travel of the acoustic waves from one of the elements to another of the elements, and wherein the output of the temperature sensing means can be used to adjust processing based on temperature and the change in speed of an acoustic wave in air due to a change in temperature.
